(19) United States
(12) Patent Application Publication
(10) Pub. No.: US 2017/0145986 A1
(43) Pub. Date: May 25, 2017

(54) CUSTOM FIT BLADE TIP FOR A ROTOR BLADE ASSEMBLY OF A WIND TURBINE AND METHOD OF FABRICATION

(71) Applicant: General Electric Company, Schenectady, NY (US)

(72) Inventors: Peggy Lynn Baehmann, Glenville, NY (US); Shridhar Champaknath Nath, Niskayuna, NY (US); Shatil Sinha, Clifton Park, NY (US)

(21) Appl. No.: 14/952,767

(22) Filed: Nov. 25, 2015

(51) Int. Cl. F03D 1/06; B29C 67/00; B33Y 50/02; B29D 99/00; B33Y 10/00; F03D 1/00; B29C 70/30

(52) U.S. Cl. CPC F03D 1/0675; F03D 1/001; B29C 67/0088; B29C 70/30; B29D 99/0028; B33Y 10/00; B33Y 50/02; F05B 2230/31; F05B 2230/50; F05B 2280/6003; B29K 2105/06

(57) ABSTRACT

A rotor blade assembly including a first blade section including a joint end and a custom fit second blade section including a joint end, and a method of fabricating the rotor blade assembly is disclosed. One of the first blade section or the custom fit second blade section includes an inner surface defining a cavity. The cavity is configured to receive the joint end of the other one of the blade sections in an overlapping configuration to define an overlapping region and a mating joint. A joining means is used to secure the joint ends of the blade sections. A profile of the outer surface of the custom fit second blade section generally corresponds to the aerodynamic profile of the first blade section such that a substantially continuous aerodynamic profile is defined between the blade sections when the joint ends are configured in the overlapping configuration.

### BACKGROUND

The present subject matter relates generally to rotor blades of a wind turbine and, more particularly, to a custom fit blade tip for a rotor blade assembly of a wind turbine.

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to improve the overall performance of wind turbines by modifying the size, shape and configuration of wind turbine rotor blades. One such modification has been to alter the configuration of the tip of the rotor blade through the installation of a blade tip component. In particular, blade tips may be specifically designed to enhance or improve various aspects of a rotor blade's performance. For example, certain blade tips may be designed to operate efficiently in specific wind classes. Additionally, blade tips may be configured to enhance specific operating conditions of the wind turbine, such as by being configured to lower torque or reduce noise.

Typically, the shape of each installed blade differs slightly making it difficult to size overlapping longer tip components to fit over each installed blade. Shape variations are a result of mold differences and blade tolerances which may lead to the formation of a non-uniform gap between the mating parts, and more particularly between the blade and the tip component. A relatively large non-uniform gap between the installed blade and the new longer tip component may cause problems in designing the attachment method for the blade tip. More specifically, due to the mold and blade variations that are possible, the gap may not be uniform between the leading and trailing edge areas, and between the suction and pressure sides. A one-size-fits-all overlapping blade tip would not provide a good fit in light of the variances of each blade.

With regard to the designing the attachment method, both mechanical and bonded joints may be utilized. A mechanically fastened joint requires the mating surfaces to touch at the locations of the fastener to avoid local dimpling of the overlapping tip; therefore shims would have to be used where a non-uniform gap exists. In addition, a non-uniform gap would not allow one size shim to be used at each fastener location. A bonded joint requires a gap between the mating surfaces, but a uniform thin gap is preferred over a commonly found non-uniform gap. Large gaps filled with adhesive will not be strong. In addition, if a low viscosity adhesive is used in conjunction with a non-uniform gap, it will readily fill the larger gap regions and not the thinner regions.

An alternative method of tip attachment allows for the tip component to be partitioned into two or three pieces; e.g. the pressure and suction sides, where one side may be further cut into two pieces for better fit. With multiple pieces, each piece would be designed to fit the undersized part and the non-uniform gaps between the pieces would have to be filled during assembly. The other option is to create the pieces to fit the nominal part or oversized blades and cut the pieces down when an undersized blade is encountered. Irrespective of the method of attachment, the presence of the non-uniform gap between the mating parts results in increased assembly costs and is thus not desirable.

Accordingly, given that different operating advantages may be provided to a wind turbine depending on the configuration of the blade tip, it would be advantageous to provide blade tip that allows for assembly on a rotor blade whereby the blade tip is custom fit for each rotor blade. Therefore, there is a need for a blade tip and method of fabrication that allows for a custom and efficient joining of the two blade sections of a rotor blade assembly.

### BRIEF DESCRIPTION

In accordance with one or more embodiments shown or described herein, a rotor blade assembly is disclosed. The rotor blade assembly including a first blade section, a custom fit second blade section and a joining means configured to secure the joint ends of the first blade section and the custom fit second blade section in the overlapping region. The first blade section includes a joint end and defining an aerodynamic profile. The custom fit second blade section includes a joint end and defining an aerodynamic profile. The first blade section and the custom fit second blade section include an inner surface and an outer surface, the inner surface defining a cavity configured to receive the joint end of the other one of the first blade section or the custom fit second blade section in an overlapping configuration defining an overlapping region and a mating joint. A profile of the outer surface of the custom fit second blade section generally corresponds to the aerodynamic profile of the first blade section such that a substantially continuous aerodynamic profile is defined between the first blade section and the custom fit second blade section when the joint ends are configured in the overlapping configuration.

In accordance with one or more embodiments shown or described herein, a rotor blade assembly for a wind turbine is disclosed. The rotor blade assembly including a first blade section including a joint end defining a geometric profile, a custom fit second blade section including a joint end. The custom fit second blade section further including an inner surface defining a cavity having a geometric profile at the joint end substantially inverse to the geometric profile of the joint end of the first blade section so as to receive the joint end of the first blade section in an overlapping configuration and define an overlapping region and a mating join. The rotor blade assembly further including a joining means configured to secure the joint ends of the first blade section and the custom fit second blade section in the overlapping region. A profile of an outer surface of the custom fit second blade section generally corresponds to an aerodynamic profile of the first blade section such that a substantially continuous aerodynamic profile is defined between the first blade section and the custom fit second blade section when the joint ends are configured in the overlapping configuration.

In accordance with one or more embodiments shown or described herein, a method of fabricating a rotor blade assembly of a wind turbine is disclosed. The method including obtaining geometric profile data of an existing rotor blade by one of scanning a profile of the existing rotor blade or obtaining a surface impression of the profile of the existing rotor blade. Next a custom tooling surface is created based on a determined geometry provided by the obtained geometric profile data, and a standardized tooling surface is created based on standardized tooling data. The custom tooling surface and the standardized tooling surface are next combined to create a combined single tooling surface. A plurality of composite layers are next layed up on the a combined single tooling surface to form a custom fit blade tip. The custom fit blade tip is next installed on the existing rotor blade to form the rotor blade assembly.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates a perspective view of a wind turbine of conventional construction;

FIG. 2 illustrates a perspective view of an embodiment of a rotor blade and tip assembly, in accordance with one or more embodiments disclosed herein;

FIG. 3 illustrates a partial, perspective view of an existing rotor blade and blade tip of the rotor blade assembly of FIG. 2 prior to assembly in mating relationship, in accordance with one or more embodiments disclosed herein;

FIG. 4 illustrates a partial, perspective view of the assembled rotor blade assembly of FIG. 3, in accordance with one or more embodiments disclosed herein;

FIG. 5 illustrates a partial, cross-sectional view of the rotor blade assembly of FIG. 4, taken through line 5-5 of FIG. 4, in accordance with one or more embodiments disclosed herein;

FIG. 6 illustrates a partial, perspective view of another embodiment of an existing rotor blade and blade tip prior to assembly in mating relationship, in accordance with one or more embodiments disclosed herein;

FIG. 7 illustrates a partial, perspective view of the assembled rotor blade assembly of FIG. 6, in accordance with one or more embodiments disclosed herein;

FIG. 8 illustrates a partial, cross-sectional view of the rotor blade assembly of FIG. 7, taken through line 8-8 of FIG. 7, in accordance with one or more embodiments disclosed herein;

FIG. 9 illustrates a partial, perspective view of yet another embodiment of an existing rotor blade and blade tip prior to assembly in mating relationship, in accordance with one or more embodiments disclosed herein;

FIG. 10 illustrates a partial, perspective view of the assembled rotor blade assembly of FIG. 9, in accordance with one or more embodiments disclosed herein;

FIG. 11 illustrates a partial, cross-sectional view of the rotor blade assembly of FIG. 10, taken through line 11-11 of FIG. 10, in accordance with one or more embodiments disclosed herein;

FIG. 12 illustrates a perspective view of an embodiment of a custom fit blade tip, in accordance with one or more embodiments disclosed herein;

FIG. 13 illustrates a method of fabricating a rotor blade assembly of a wind turbine, in accordance with one or more embodiments disclosed herein;

FIG. 14 illustrates a tool or mold for use in the method of fabricating a rotor blade assembly of a wind turbine, in accordance with one or more embodiments disclosed herein; and

FIG. 15 illustrates an alternate tool or mold for use in the method of fabricating a rotor blade assembly of a wind turbine, in accordance with one or more embodiments disclosed herein.

### DETAILED DESCRIPTION

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

In general, the present subject matter is directed to a custom fit blade tip for a rotor blade, to form a rotor blade assembly of a wind turbine and a method of fabrication. In particular, the custom fit blade tip is designed to provide a custom fit and accommodate variances from one blade to the next in a rotor blade assembly. The custom fit blade tip may define a cavity configured to receive an end of a rotor blade. For example, the cavity may generally have a shape corresponding to the exterior shape of the end of the rotor blade, such as by having a tapered, profile corresponding to the tapered, aerodynamic profiles of the blade end, and configured so as to form a controlled uniform gap defined between the mating surfaces, and more particularly between an interior surface of the custom fit blade tip and an exterior surface of the rotor blade at an overlapping region. Alternatively, the custom fit blade tip may be configured for receipt within a cavity formed in an existing rotor blade. In addition, the custom fit blade tip may include a tapered, aerodynamic profile on an exterior surface at a mating joint. An adhesive may be incorporated within the uniform gap formed between the mating surfaces, in an overlapping region and about a periphery of the rotor blade. Alternatively, thermoplastic welding may be used join the mating surfaces, or fasteners may be incorporated around a periphery of the rotor blade assembly at the overlapping region to secure the custom fit blade tip and existing blade to one another.

The disclosed custom fit blade tip may generally provide for the efficient assembly of a tip component on an existing rotor blade, irrespective of variances in dimension of the plurality of blades in the rotor assembly. The custom fit blade tip may be easily assembled thereon or removed from the rotor blade for purposes of maintenance, repairs and/or for upgrading the performance of the rotor blade assembly. For example, it may be preferable to vary the tip section of the rotor blade depending on the wind turbine operating conditions and/or the desired performance of the rotor blade assembly. Thus, by providing a custom fit, each blade tip may be fabricated having differing dimensions based on geometric data of a mating blade to which it is to be attached. In addition, different configurations and/or aerodynamic features of the custom fit blade tip may be provided for each blade variance, such as a straight tip section (e.g., a tip section extending in a substantially spanwise direction), a winglet-type tip section, or the like.

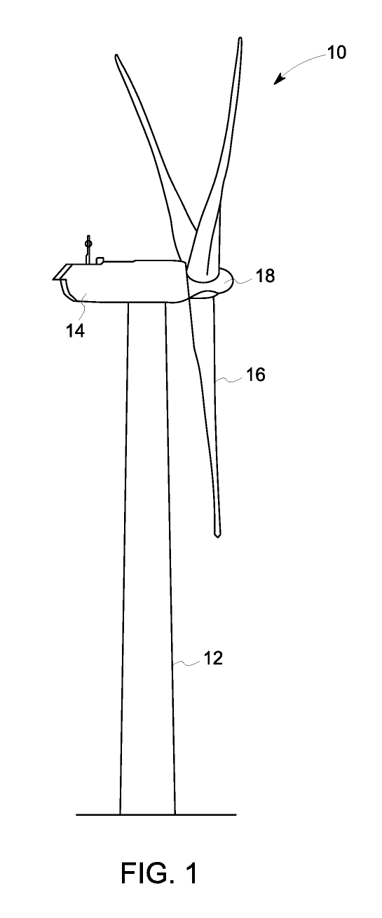

Referring now to the drawings, FIG. 1 illustrates a perspective view of a wind turbine 10 of conventional construction. The wind turbine 10 includes a tower 12 with a nacelle 14 mounted thereon. A plurality of rotor blades 16 are mounted to a rotor hub 18, which is, in turn, connected to a main flange that turns a main rotor shaft. The wind turbine power generation and control components are housed within the nacelle 14. It should be appreciated that the wind turbine 10 of FIG. 1 is provided for illustrative purposes only to place the present subject matter in an exemplary field of use. Thus, one of ordinary skill in the art should readily appreciate that the scope of the present subject matter is not limited to any particular type of wind turbine configuration

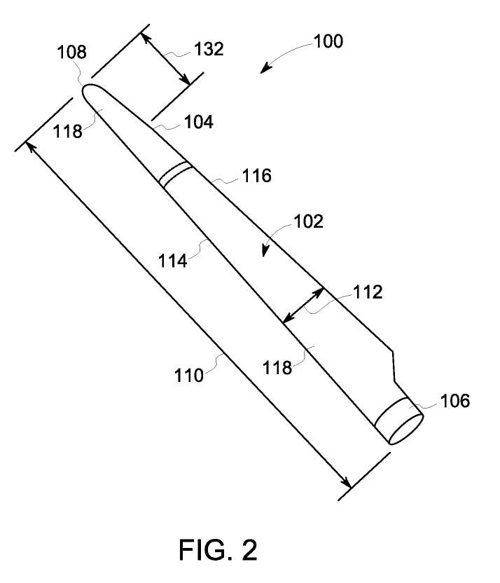

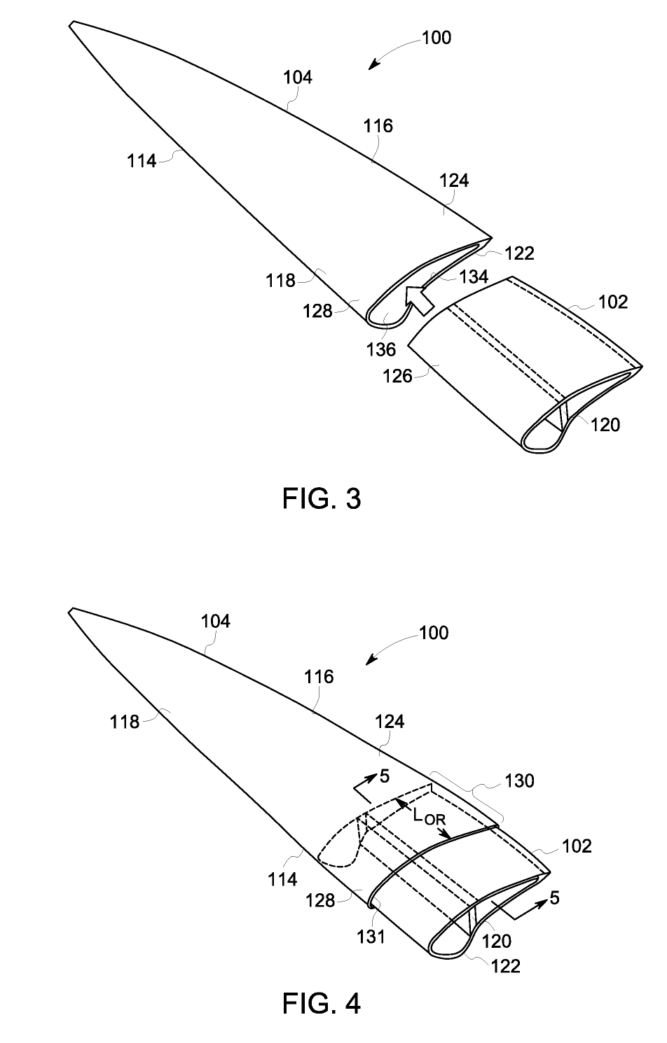

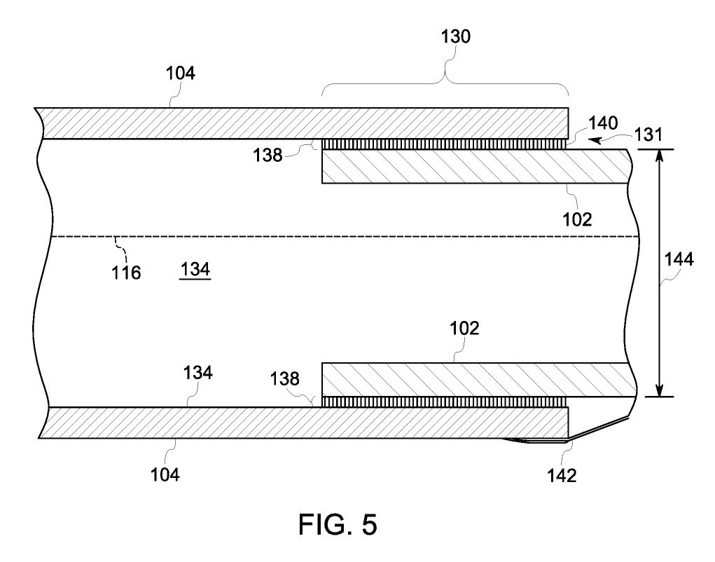

Referring now to FIGS. 2-11, embodiments of a rotor blade assembly including a rotor blade, referred to herein as a first blade section, having custom fit blade tip, referred to herein as a second blade section, disposed in mating relationship, are illustrated in accordance with aspects of the present subject matter. In particular, FIG. 2 illustrates a perspective view of a first embodiment of an assembled rotor blade assembly 100. FIG. 3 illustrates a partial, perspective view of the unassembled components of the rotor blade assembly 100 of FIG. 2, particularly illustrating a first blade section 102 and a second blade section 104 prior to assembly in mating relationship. FIGS. 4 and 5 illustrate a partial, perspective view and a partial cross-section, respectively, of the rotor blade assembly 100 of FIG. 2, particularly illustrating the first blade section 102 disposed in mating relationship with the second blade section 104 of the rotor blade assembly 100.

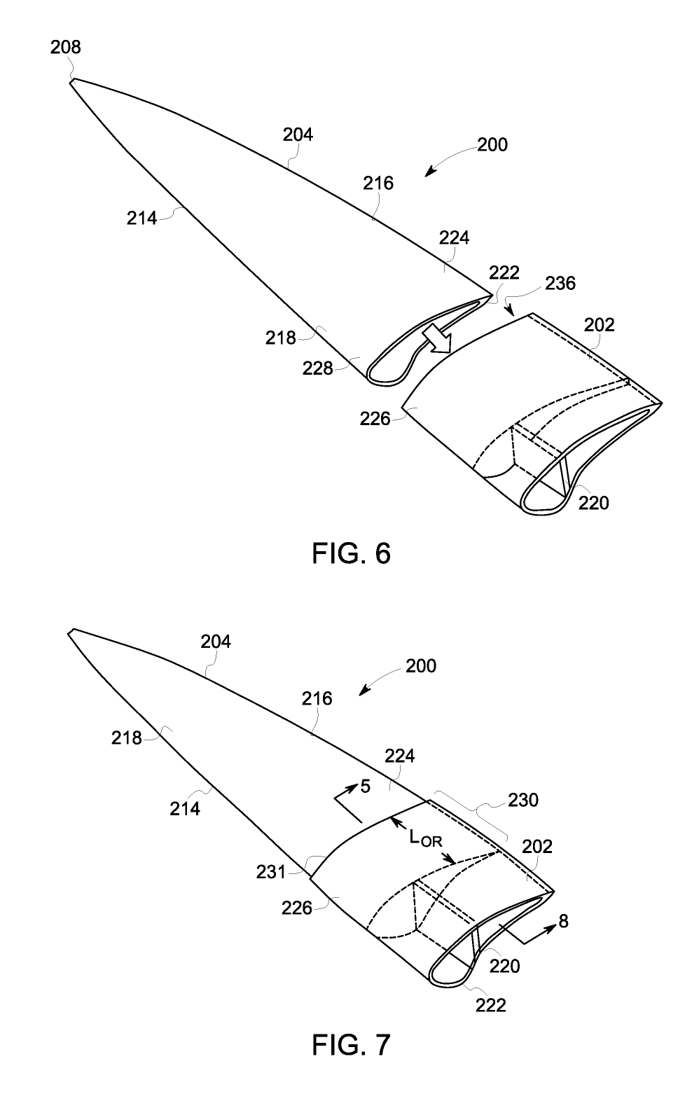

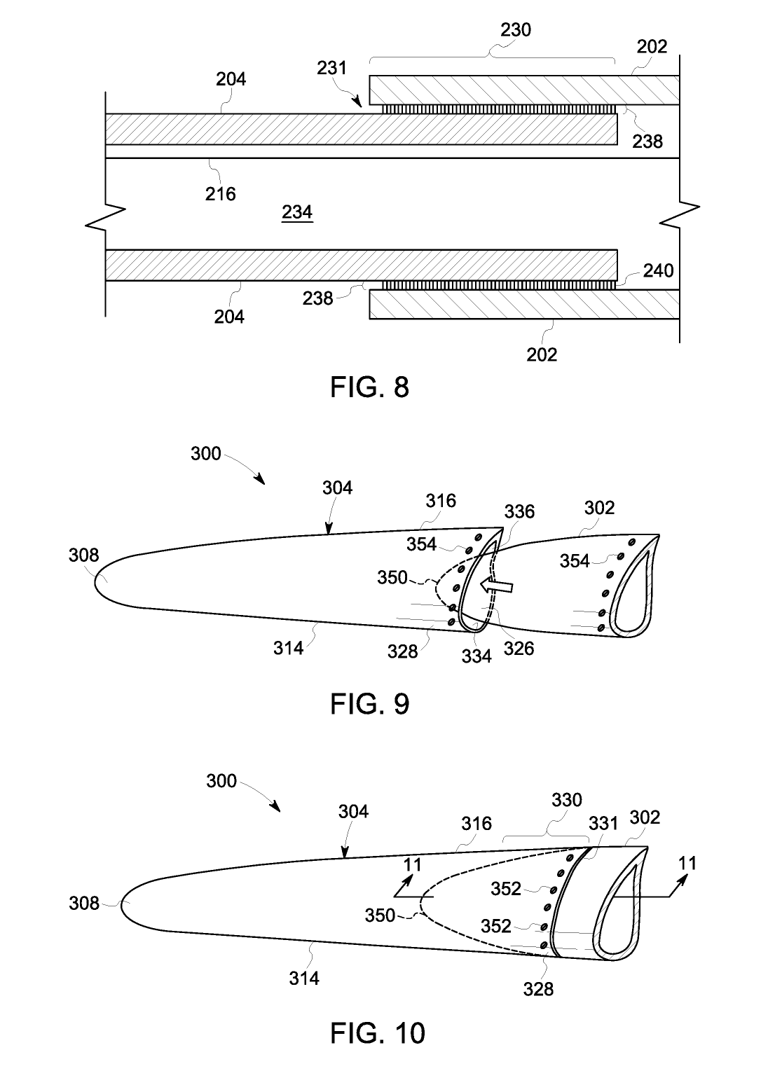

FIG. 6 illustrates a partial, perspective view of the unassembled components of a rotor blade assembly 200 of a second embodiment, particularly illustrating a first blade section 202 and the second blade section 204 prior to assembly in mating relationship. FIGS. 7 and 8 illustrate a partial, perspective view and a partial cross-section, respectively, of the rotor blade assembly 200 illustrated in FIG. 6, particularly illustrating the first blade section 202 disposed in mating relationship with the second blade section 204 of the rotor blade assembly 200.

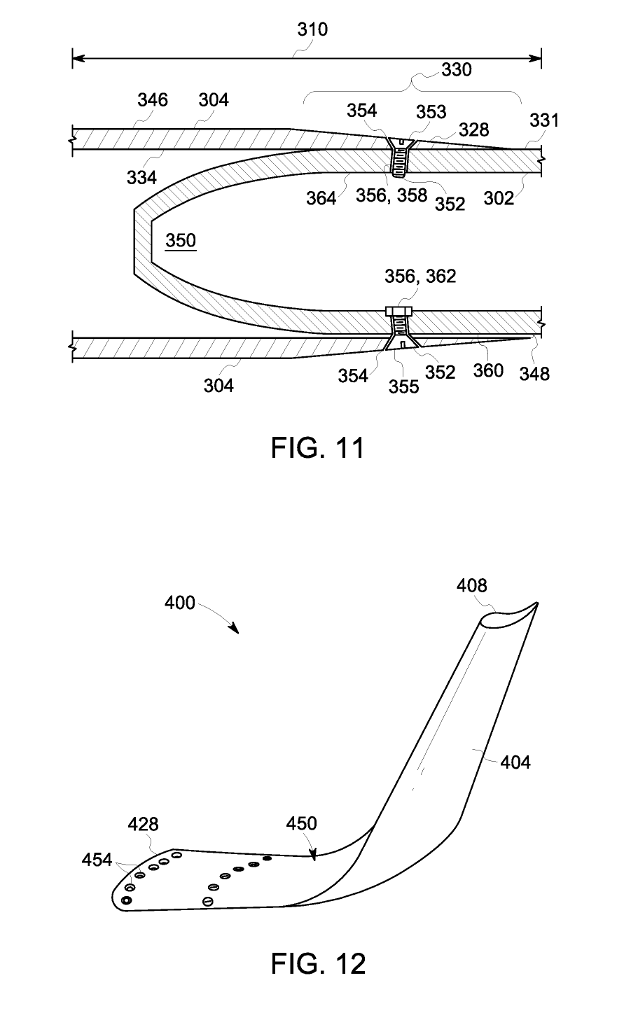

FIG. 9 illustrates a partial, perspective view of the unassembled components of a rotor blade assembly 300 of a third embodiment, particularly illustrating a first blade section 302 and the second blade section 304 prior to assembly in mating relationship. FIGS. 10 and 11 illustrate a partial, perspective view and a partial cross-section, respectively, of the rotor blade assembly 300 illustrated in FIG. 9, particularly illustrating the first blade section 302 disposed in mating relationship with the second blade section 304 of the rotor blade assembly 300.

Referring more specifically to the first embodiment, and FIGS. 2-5, as shown, the rotor blade assembly 100 includes the first blade section 102 disposed in mating relationship, and more particularly disposed in partial overlying relationship, with the second blade section 104. In general, the rotor blade assembly 100 may be configured such that, when the first and second blade sections 102 and 104 are attached to one another, the complete rotor blade assembly 100, defining a substantially aerodynamic profile, is formed. Thus, the complete rotor blade assembly 100 may generally include a blade root 106 (defined as part of the first blade section 102) configured to be mounted to the hub 18 (FIG. 1) of a wind turbine 10 and a blade tip 108 (defined by the second blade section 104) disposed opposite the blade root 106. The rotor blade assembly 100 may also include a span 110 defining the total length between the blade root 106 and the blade tip 108 and a chord 112 defining the total length between a leading edge 114 and a trailing edge 116. As is generally understood, the chord 112 may vary in length with respect to the span 110 as the rotor blade extends from the blade root 106 to the blade tip 108.

In general, the first and second blade sections 102, 104 of the rotor blade assembly 100 may be configured similarly to any suitable blade section and/or blade segment known in the art. For example, each blade section 102, 104 may include a body shell 118 serving as the outer casing/covering of the blade section 102, 104 and one or more structural components 120, as shown in FIGS. 3 and 4, for providing stiffness and/or strength to the blade sections 102, 104 (e.g., a shear web/spar cap assembly). Additionally, the mating of the first blade section 102 and the second blade section 104 may generally define an aerodynamic profile. For instance, the body shells 118 of each blade section 102, 104 may be configured to define an airfoil shaped cross-section, such as a symmetrical or cambered airfoil shaped cross-section. Thus, as shown in FIGS. 3 and 4, each body shell 118 may generally define a pressure side 122, and a suction side 124 extending between the leading edge 114 and the trailing edge 116.

It should be appreciated that the body shells 118 may generally be formed from any suitable material. For instance, in one embodiment, each body shell 118 may be formed entirely from a laminate composite material, such as a carbon fiber-reinforced composite or a glass fiber-reinforced composite. Alternatively, one or more portions of each body shell 118 may be configured as a layered construction and may include a core material, formed from a lightweight material such as wood (e.g., balsa), foam (extruded polystyrene foam) or a combination of such materials, disposed between layers of laminate composite material.

Referring more specifically to FIGS. 3 and 4, the first and second blade sections 102, 104 may each include a joint end 126, 128, respectively, and an overlapping region 130, defining a mating joint 131, defined by the overlapping portions of the first and second blade sections 102, 104 after assembly. Thus, in the illustrated first embodiment, the first blade section 102 may generally extend from the blade root 108 (FIG. 2) of the rotor blade assembly 100 to its joint end 126. In this particular embodiment, the first blade section 102 has been altered, such as by cutting, to remove an original tip portion (not shown) of the first blade section 102. In an alternate embodiment, as best illustrated in FIGS. 9-11 (described presently), the original tip portion of the first blade section remains intact, having not been removed prior to assembly with the second blade section. Referring again to FIGS. 3 and 4, the second blade section 102 may generally extend from its joint end 128 to the blade tip 108 of the custom fit blade tip, and more particularly of the second blade section 104. The joint end 128 of the second blade section 104 may define a particular profile in order to facilitate a stepped or substantially smooth transition between the first and second blade sections 102, 104 at the mating joint 131. For instance, in the illustrated embodiment of FIGS. 2-5, the second blade section 104 defines a stepped profile at its joint end 126. Alternatively, the joint end 128 of blade section 104 may define a tapered profile (described presently).

As shown in FIG. 2, the first blade section 102 may generally extend lengthwise along a substantial portion of the span 110 of the rotor blade assembly 100 such that the custom fit blade tip, and more particularly the second blade section 104 is disposed at an outboard position on the rotor blade. Thus, in the illustrated embodiment, the second blade section 104 is configured similarly to the outboard portion of a conventional rotor blade 16 (FIG. 1), such as by extending in a substantially spanwise direction between the joint end 128 of the second blade section 104 and the blade tip 108. Alternatively, as will be described below with reference to FIG. 12, the second blade section 104 may be configured as a winglet-type tip section or may otherwise have any other suitable tip configuration know in the art, such as an extension section, or the like.

It should be appreciated that, in embodiments in which the second blade section 104 is configured as an outboard or tip section of the rotor blade assembly 100, the second blade section 104 may generally define a relatively short length 132. For example, in several embodiments, the second blade section 104 may define a length 132 which is less than 10 meters (m) long, such as less than 5 m long or less than 3 m long and all other subranges therebetween. However, in alternative embodiments, the second blade section 104 need not be configured as a tip section of the rotor blade assembly 100 and, thus, may generally define any suitable length 132, such as a length greater than or equal to 10 m. In such embodiments, it should be appreciated that the overlapping region 130, and thus the mating joint 131, may generally be disposed at any suitable location along the span 110 of the rotor blade assembly 100, such as by being located at a more inboard position closer to the blade root 106.

Still referring to FIGS. 2-5, the second blade section 104 may generally have any suitable configuration that permits the joint end 126 of the first blade section 102 to be received within the second blade section 104. For example, the second blade section 104 may have a hollow or a substantially hollow configuration for receiving the joint end 126 of the first blade section 102. In particular, as shown in FIG. 3, the second blade section 104 may generally include an inner perimeter or inner surface 134 defining a cavity 136 extending a length between the joint end 128 and the blade tip 108 of the second blade section 104. The cavity 136 is configured having a geometric profile at the joint end 128 substantially inverse to a geometric profile (described presently) of the joint end 126 of the first blade section 102, so as to receive the joint end 126 of the first blade section 102 in an overlapping configuration and define the overlapping region 130 and the mating joint 131.

To provide for such disposing of the first blade section 102 within the cavity 136 of the second blade section 104, the second blade section 104 is custom made utilizing geometric data, such as measurements, surface molds, or the like of the first blade section 102. The ability to fabricate the custom fit blade tip, and more particularly the second blade section 104 provides for the formation of a controlled uniform gap 138 between the first blade section 102 and the second blade section 103 extending about a periphery of the rotor blade assembly 100 and along a length “L_{OR}” of the overlapping region 130, as best illustrated in FIG. 4.

It should be appreciated that the joint end 126 of the first blade section 102 may generally be attached within the cavity 136 of the second blade section 104 using any suitable means. For example, in the illustrated embodiment of FIGS. 2-5, the joint end 126 may be bonded within the second blade section 104 using any suitable adhesive 140 to fill the uniform gap 138. In another embodiment, a plurality of fasteners (described presently) may be utilized to secure the first blade section 102 and the second blade section 104 in the partial overlapping, or mating, relationship. In yet another embodiment thermoplastic welding may be used to secure the first blade section 102 and the second blade section 104.

It should be appreciated that, in several embodiments, an additional surface feature may be applied to or positioned over the mating joint 131 formed at the interface of the blade sections 102, 104 to ensure that a substantially smooth aerodynamic surface is achieved. For example, in a particular embodiment, and as best illustrated in a lower portion of FIG. 5, several plies of a laminate composite material 142 may be applied around the outer perimeter of the rotor blade assembly 100 at the joint seam, and more particularly at the mating joint 131, between the first blade section 102 and the second blade section 104, such as by using a wet lay-up process, to provide a substantially flush aerodynamic surface between the blade sections 102, 104. In an alternate embodiment, paste or a preformed part could also be placed at the formed at the interface of the blade sections 102, 104 to ensure that a substantially smooth aerodynamic surface is achieved.

Referring now to a second disclosed embodiment, and FIGS. 6-8, a rotor blade assembly 200 includes the first blade section 202 disposed in mating relationship, and more particularly disposed in partial overlying relationship, with the second blade section 204. In general, the rotor blade assembly 200 may be configured such that, when the first and second blade sections 202 and 204 are attached to one another, the complete rotor blade assembly 200, defining a substantially aerodynamic profile, is formed. Thus, the complete rotor blade assembly 200 may generally include a blade root, generally similar to blade root 106 of FIG. 2, configured to be mounted to the hub 18 (FIG. 1) of a wind turbine 10 and a blade tip 208 (defined by the second blade section 204) disposed opposite the blade root. The rotor blade assembly 200 may also include a span, generally similar to span 110 of FIG. 2, defining the total length between the blade root and the blade tip 208 and a chord, generally similar to chord 112 of FIG. 2, defining the total length between a leading edge 214 and a trailing edge 216. As is generally understood, the chord may vary in length with respect to the span as the rotor blade extends from the blade root to the blade tip 208. It should be understood that additional features of the rotor blade assembly 200 that have been previously described with regard to the embodiment of FIGS. 2-5 will be referenced in FIGS. 6-8 having the same reference number with a “2” replacing the “1” as the first digit to indicate another embodiment. The rotor blade assembly 200 may be somewhat similar to the rotor blade assembly 100, and thus a detailed description will be omitted for the sake of brevity as to like features.

Referring more specifically to FIG. 6, the first and second blade sections 202, 204 may each include a joint end 226, 228, respectively, and an overlapping region 230 and mating joint 231, defined by the overlapping portions of the first and second blade sections 202, 204. Similar to the embodiment of FIGS. 2-5, in this particular embodiment, the first blade section 202 has been altered, such as by cutting, to remove an original tip portion (not shown) of the first blade section 202. The custom fit blade tip, and more particularly the second blade section 204 is disposed at an outboard position on the rotor blade. Thus, in the illustrated embodiment, the second blade section 204 is configured similarly to the outboard portion of a conventional rotor blade 16 (FIG. 1). Alternatively, the second blade section 204 may be configured as a winglet-type tip section or may otherwise have any other suitable tip configuration know in the art, such as an extension section, or the like

In this particular embodiment, the first blade section 202 may generally have any suitable configuration that permits the joint end 228 of the second blade section 204 to be received within the first blade section 202. For example, first blade section 202 may have a hollow or a substantially hollow configuration for receiving the joint end 228 of the second blade section 204. The joint end 228 of the second blade section 204 may be configured to be received within a cavity 236 defined at the joint end 226 of the first blade section 202.

To provide for such disposing of the second blade section 204 within the cavity 236 of the first blade section 202, the second blade section 204 is custom made utilizing geometric data, such as measurements, surface molds, or the like of the first blade section 202. The ability to fabricate the custom fit blade tip, and more particularly the second blade section 204 provides for the formation of a uniform gap 238 between the first blade section 202 and the second blade section 204 extending about a periphery of the rotor blade assembly 200 and along a length “L_{OR}” of the overlapping region 230, as best illustrated in FIG. 7.

Similar to the embodiment of FIGS. 2-5, the joint end 228 of the second blade section 204 may generally be attached within the cavity 236 of the first blade section 202 using any suitable means. For example, in the illustrated embodiment of FIGS. 6-8, the joint end 228 may be bonded within the first blade section 202 using any suitable adhesive 240 to fill the uniform gap 238. In another embodiment, a plurality of fasteners (described presently) may be utilized to secure the joint end 228 within the first blade section 202. In yet another embodiment thermoplastic welding may be used to secure the joint end 228 within the first blade section 202.

Similar to the previous embodiment, an additional surface feature (not shown) may be applied to or positioned over the mating joint 231 formed at the interface of the blade sections 202, 204, such as several plies of a laminate composite material 142 (FIG. 5) to ensure that a substantially smooth aerodynamic surface is achieved.

Referring now to a third disclosed embodiment, and FIGS. 9-11, a rotor blade assembly 300 includes the first blade section 302 disposed in mating relationship, and more particularly disposed in partial overlying relationship, with the second blade section 304. In general, the rotor blade assembly 300 may be configured such that, when the first and second blade sections 302 and 304 are attached to one another, a complete rotor blade assembly 300, defining a substantially aerodynamic profile, is formed. Thus, the complete rotor blade assembly 300 may generally include a blade root (not shown), generally similar to blade root 106 of FIG. 2, configured to be mounted to the hub 18 (FIG. 1) of a wind turbine 10 and a blade tip 308 (defined by the second blade section 304) disposed opposite the blade root. The rotor blade assembly 300 may also include a span, generally similar to span 110 of FIG. 2, defining the total length between the blade root and the blade tip 308 and a chord, generally similar to chord 112 of FIG. 2, defining the total length between a leading edge 314 and a trailing edge 316. As is generally understood, the chord may vary in length with respect to the span as the rotor blade extends from the blade root to the blade tip 308. It should be understood that additional features of the rotor blade assembly 300 that have been previously described with regard to the embodiment of FIGS. 2-5 will be referenced in FIGS. 9-11 having the same reference number with a “3” replacing the “1” as the first digit to indicate another embodiment. The rotor blade assembly 300 may be somewhat similar to the rotor blade assemblies 100, 200 previously disclosed, and thus a detailed description will be omitted for the sake of brevity as to like features.

Referring more specifically to FIG. 9, the first and second blade sections 302, 304 may each include a joint end 326, 328, respectively, and an overlapping region 330 and a mating joint 331, defined by the overlapping portions of the first and second blade sections 302, 304. In contrast to the embodiment of FIGS. 2-8, in this particular embodiment, the first blade section 302 has not been altered, with an original tip portion 350 of the first blade section 302 remaining intact. The custom fit blade tip, and more particularly the second blade section 304 is disposed at an outboard position on the rotor blade. Thus, in the illustrated embodiment, the second blade section 304 is configured similarly to the outboard portion of a conventional rotor blade 16 (FIG. 1). Alternatively, the second blade section 304 may be configured as a winglet-type tip section or may otherwise have any other suitable tip configuration know in the art, such as an extension section, or the like.

Similar to the embodiment of FIGS. 2-5, in this particular embodiment, the second blade section 304 may generally have any suitable configuration that permits the joint end 326 of the first blade section 302 to be received within the second blade section 304. For example, second blade section 304 may have a hollow or a substantially hollow configuration for receiving the joint end 326 of the first blade section 302. In particular, as shown in FIG. 9, the second blade section 304 may generally include an inner perimeter or inner surface 334 defining a cavity 336 extending a length between the joint end 328 and the blade tip 308 of the second blade section 304. As such, the joint end 326 of the first blade section 302 may be configured to be received within the portion of the cavity 336 defined at the joint end 328 of the second blade section 304.

To provide for such disposing of the first blade section 302 within the cavity 336 of the second blade section 304, the second blade section 304 is custom made utilizing geometric data, such as measurements, surface molds, or the like of the first blade section 302. The ability to fabricate the custom fit blade tip, and more particularly the second blade section 304 provides for the formation of a controlled uniform gap 338, as best illustrated in a lower portion of FIG. 11, prior to complete fastening of the fasteners (described presently).between the first blade section 302 and the second blade section 303.

Similar to the embodiment of FIGS. 2-5, the joint end 326 of the first blade section 302 may generally be attached within the cavity 336 of the second blade section 304 using any suitable means. For example, in the illustrated embodiment of FIGS. 9-11, a plurality of fasteners 352 may be utilized to secure the joint end 326 of the first blade section 302 within the joint end 328 of the second blade section 304. In another embodiment, the joint end 326 may be bonded within the second blade section 304 using any suitable adhesive to fill the uniform gap 338. In yet another embodiment thermoplastic welding may be used to secure the joint end 326 within the second blade section 304.

For example, as shown in FIG. 11, the second blade section 304 may define a plurality of openings 354 extending between its inner surface 334 and an outer surface 346, with each opening 354 being configured to receive a fastener 352. Specifically, a plurality of openings 354 may be defined proximate to a root end 348 of the second blade section 304 to permit a like number of fasteners 352 to be inserted through the openings 354 and attached to the joint end 326 of the first blade section 302. Similarly, a plurality of openings 354 may be defined proximate the tip end 350 of the first blade section 304 to permit the like number of fasteners 352 to be inserted through the openings 354. It should be readily appreciated that the openings 354 may be defined so as to form any suitable bolt hole pattern. For example, in one embodiment, the openings 354 may form a single row along the outer surface 346 of the second blade section 304 and the tip end 350 of the first blade section 302. In another embodiments, multiple rows (e.g., two or more rows) of openings 354, being aligned or offset from one another, may be defined in the root end 348 of the second blade section 304 and the tip end 350 of the first blade section 302.

In particular, the openings 344 may be configured such that the fasteners 352 are recessed partially or fully within the second blade section 302. For example, as shown in FIG. 11, the recessed openings 344 may be configured such that a top surface 353 of each fastener 352 is positioned substantially flush with the outer surface 346 of the second blade section 302. As such, the second blade section 302 may generally define a substantially continuous aerodynamic profile between its tip and root ends 308, 348, respectively.

It should be appreciated that the size, shape and/or configuration of the recessed features of the openings 354 may generally vary depending on the size, shape and/or configuration of the fasteners 352 being used to attach the blade sections 302, 304. For example, as shown in FIG. 11, the fasteners 352 may generally comprise threaded fasteners having a fastener head 355 defining a tapered diameter. In such an embodiment, the openings 354 formed in the second blade section 104 may generally define a corresponding tapered diameter such that the fastener head 355 may be fully recessed within the second blade section 104 as previously described.

Referring still to FIG. 11, to ensure proper attachment of the second blade section 304 to the first blade section 302, the disclosed rotor blade assembly 300 may also include features for retaining the disclosed fasteners 352 within the joint ends 326, 328 of the blade sections 302, 304. For example, in embodiments in which the fasteners 352 are configured as a threaded fasteners (e.g., threaded bolts), the rotor blade assembly 300 may include a plurality of female threaded members 356 configured to receive the threaded fasteners 352 such that the overlapping region 330 is defined between the inner surface 334 of the joint end 328 of the second blade section 302 and an outer surface 360 of the joint end 326 of the first blade section 302. Thus, as shown in FIG. 11, the plurality of female threaded members 356 may be configured to be aligned with the openings 354 defined in the second blade section 304 such that the fasteners 352 may be inserted through the openings 354 and screwed into the threaded members 356. The threaded members 356 may comprise a plurality threaded channels or plugs 358 configured to be mounted or otherwise disposed within the joint end 326 of the first blade section 302. In another embodiment, the threaded members 356 may comprise a plurality of nuts 362 mounted directly or indirectly to an inner surface 364 of the first blade section 302. For example, as shown in FIG. 11, the nuts 362 may be mounted onto a ganged channel or nut plate extending around the inner perimeter of each blade shell 320. It should be appreciated that the nuts 362 may generally comprise any suitable nut known in the art, including conventional, threaded nuts and floating nuts. Additionally, in alternative embodiments, it should be appreciated that the plurality of threaded members 356 may have any other suitable configuration that permits the fasteners 352 to be securely attached to the joint ends 326, 328 of the first and second blade sections 302, 304.

It should also be appreciated that the fasteners 352 described herein may generally comprise any suitable fasteners known in the art. For example, in several embodiments, the fasteners 352 may be configured as threaded fasteners, such as threaded bolts, screws and other suitable threaded fastening devices. In other embodiments, the fasteners may comprise other suitable fastening and/or attachment devices, such as pins, clips, brackets, rods, rivets, bonded fasteners and the like.

The disclosed joint end 328 of the second blade section 304 and the mating joint 331 may also define a substantially aerodynamic profile. For example, as shown in FIG. 11, in several embodiments of the present subject matter, the aerodynamic profile defined by the overlapping region 330 and the mating joint 331 may generally correspond to or otherwise match the aerodynamic profiles of the first and second blade sections 302, 304. In particular, the aerodynamic profile of the second blade section 304 at the root end 348 may generally correspond to the aerodynamic profile of the first blade section 102. As such, when the blade sections 302, 304 are assembled together, the rotor blade assembly 300 may generally define a substantially continuous aerodynamic profile along its entire span 310. For instance, as shown in FIG. 11, the second blade section 304 may be configured such that a substantially flush, aerodynamic surface is defined at the interface of the first blade section 304 and the root end 348 of the second blade section 304. Thus, the rotor blade assembly 300 may generally define a continuous aerodynamic surface between the first and second blade sections 302, 304.

Referring now to FIG. 12, there is illustrated a portion of another embodiment of a rotor blade assembly 400, and specifically a perspective view of an alternate embodiment of the custom fit blade tip, and more particularly a second blade section, generally referenced 404 in accordance with aspects of the present subject matter. In general, the second blade section 404 includes a joint end 428 and a tip end 408. The joint end 428 may generally be configured similarly to the joint end 128 described above with reference to FIGS. 2-5. Thus, the joint end 428 may define a cavity 136 (FIG. 3) extending a length between the joint end 428 and the tip end 408 of the second blade section 404. The portion of the cavity defined at the joint end 428 may generally be configured to receive a joint end 126 of the first blade section 102 (FIGS. 2-5). Additionally, the second blade section 404, and more particularly the joint end 428, may define an aerodynamic profile generally corresponding to the aerodynamic profile of the first blade section. As such, when the first blade section 102 is inserted within the second blade section 404, the tip assembly 400 may generally define a substantially continuous aerodynamic profile between the first blade section 102 and the second blade section 404.

In the embodiment of FIG. 12, the second blade section 404 is configured as a winglet-type tip section. As such, a winglet 450 may generally be defined between the joint end 428 and the blade tip 408. It should be appreciated that the winglet 450 may have any suitable configuration known in the art. For example, the winglet 450 may be configured as a suction side winglet or as a pressure side winglet. Additionally, the winglet 450 may define any suitable sweep angle, cant angle, toe angle and/or twist angle, all of which are commonly known terms in the aerodynamic art. Further, the winglet 450 may define any suitable radius of curvature and may have any suitable aspect ratio (i.e., ratio of the span of the winglet 450 to the planform area of the winglet 450).

It should be appreciated that the disclosed second blade section 404 may generally be configured as a replaceable tip for a rotor blade. Thus, the second blade section 404 may be configured to be attached to any suitable inboard blade segment or section of a rotor blade that defines the first blade section 102 (FIG. 2). For example, the portion of the cavity 136 (FIG. 4) defined at the joint end 428 of the second blade section 404 may be configured to receive the joint end 126 of the first blade section 104 described above with references to FIGS. 2-5. Thus, the end of the first blade section 102 may be formed, machined or otherwise shaped such that the first blade section 102 may be inserted into the second blade section 404. Similar to the embodiments described above, the blade sections may then be attached using a plurality of fasteners inserted through a plurality of openings 454 defined along the joint end 428.

In one or more of the disclosed embodiments, one or more of the joint ends, such as joint end 126, 128 (FIG. 3) of the first and second blade sections 102, 104 (FIG. 2), may generally be configured to be attached within the cavity, such as cavity 136 (FIG. 3), defined in either the first or second blade sections, such as 102, 104, such that a substantially continuous aerodynamic profile is defined along the span 112 (FIG. 2) of the rotor blade assembly and, particularly, at the interface between the first and second blade sections. Thus, in several embodiments, a cross-sectional height 144, as best illustrated in FIG. 5, of one of the first or second blade sections 102, 104 may generally be reduced at the joint end 126, 128 to permit the joint end 126, 128 to be inserted within the respective other blade section and to ensure that a substantially continuous or flush surface is defined between the blade sections 102, 104. Alternatively, as previously alluded to, one of the joint ends 126, 128 of the first and second blade sections 102, 104 may define a stepped profile, such as by configuring the blade shells 118 to have a stepped reduction in thickness at one of the joint ends 126, 128 so that the outer surface of one of the first or second blade sections 102, 104 is positioned substantially flush with the outer surface of the other one of the first or second blade sections. In further embodiments, it should be appreciated that the joint ends, such as joint ends 126, 128 of the blade sections, such as first blade section 102 and second blade section 104 may generally have any other suitable configuration that permits a joint end of one to be inserted into the other.

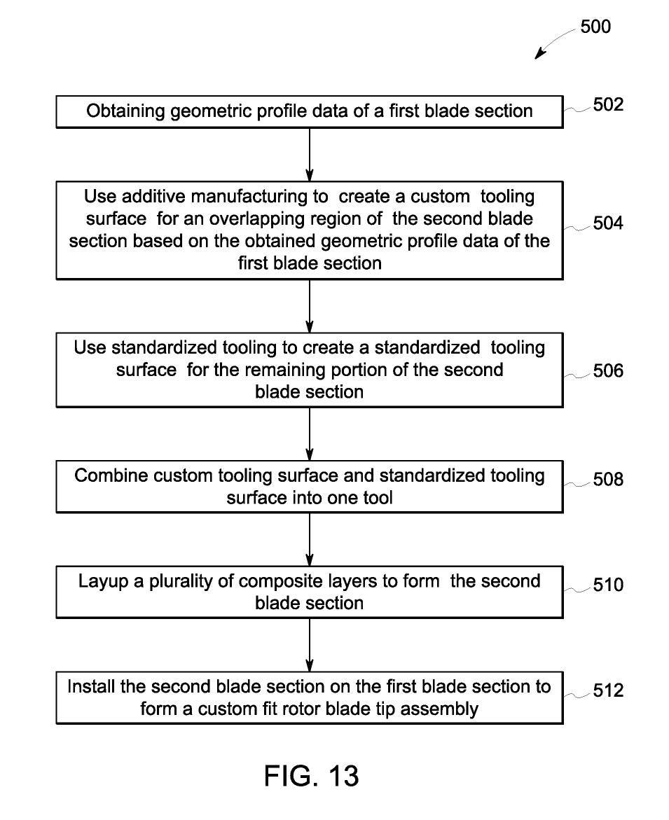

In general, second blade section 104, 204, 304, 404 may be formed using any suitable means that provides for a custom fit to the first blade section 102, 202, 302. For example, in one embodiment, the second blade section 104, 204, 304, 404 and more specifically the blade shells 118, may be fabricated by creating a mold having geometric profile defined therein or by placing a mold insert defining the profile within the mold as the blade shells 118 are being formed. Referring more specifically to FIGS. 13-15, illustrated is a method 500 and mold 600 for use in fabricating the custom fit blade tip, and more particularly the second blade section, according to this disclosure. The method and mold will be described with particular reference to FIGS. 2-5 for ease in describing, but is applicable to fabricate any of the second blade sections 104, 204, 304, 404 described herein.

In an initial step 502, geometric profile data, such as measurements, surface molds, or the like of the first blade section 102 is obtained. To accomplish such, in an embodiment, the first blade section 102 may be scanned to permit the exact geometry of such profile(s) to be known. For example, in one embodiment, a metrology or other 3-D scan may be performed on the joint end 126 of the first blade section 102 to obtain measurement data. Alternatively, a surface impression of the joint end 126 of the first blade section 102 may be taken to obtain measurement data. A tool, or mold, 600 is next prepared for fabricating the second blade section 104 based on the obtained data provided by the scan or impression to ensure that the second blade section 104, custom fits the profile of the first blade section 102 and a uniform gap 138 is formed at the overlapping region 130. In an embodiment, additive manufacturing may be used to create a custom tooling surface, and more particularly a mold insert (described presently), for the overlapping region 130 of the second blade section 104 based on the obtained geometric profile data of the first blade section 102, in a step 504. In an alternate embodiment, known manufacturing practice may be used to create the custom tooling surface, and more particularly the mold insert. Next, in a step 506, standardized tooling is used to create a tooling surface for the remaining portion of the second blade section 104. The custom tooling surface and the standardized tooling surface are combined to create a single tool or mold, in a step 508. The second blade section 104 is next fabricating by laying up a plurality of composite layers to form the second blade section 104, in a step 510. Finally in a step 512, the fabricated second blade section 104 is installed on the first blade section 102 to form a rotor blade assembly 100.

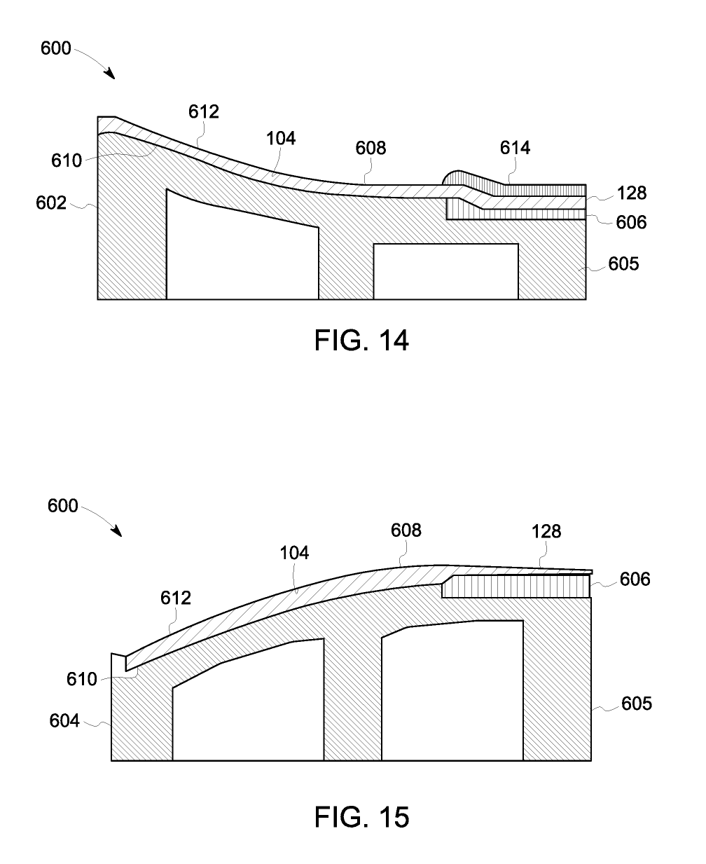

As best illustrated in FIG. 14, a tool 600 may comprise a female tool, or mold, 602 for molding the second blade section 104. As best illustrated in FIG. 15, a male tool, or mold, 604 may be provided for molding the second blade section 104. Irrespectively of the type of mold concept utilized, female or male, the method described is substantially similar. A custom tooling surface, and more particularly a mold insert, 606 is fabricated based on the obtained geometric profile data provided by the scan, or surface impression, of the first blade section 102. More particularly, in an embodiment the mold insert 606 is configured to provide a geometric profile of the joint end of the second blade section 104 that is substantially inverse to the geometric profile of the joint end of the first blade section 102 so as to enable a custom fit of the second blade section 104 relative to the first blade section 102 when positioned in an overlapping configuration. To accomplish such, the custom mold insert 606 is positioned relative to a standardized tooling surface 605, to form the female tool, or mold, 602 or the male tool, or mold, 604. A plurality of composite material layers 608 are layed up and sealed against the tool 602, 604, such as with a sheet of plastic (a “bag”) or other soft tooling approach, along with one or more venting layers. A tool side 610, i.e. the side against the tool 602, 604, of the resultant composite part, and more particularly the second blade section 104, will be shaped like the tool 602,604. An opposed side, referred to herein as a bag side 612, will not be held to an exact shape. In an alternate embodiment, a similar approach may be applied for prepreg materials.

When utilizing the female tool 602 of FIG. 14, a custom caul 614, as best illustrated in FIG. 14, may be positioned on the bag side 612 to ensure the second blade section 104 has the desired shape on a respective surface, and more particularly at the joint end 128 of the second blade section 104.

If the male tool 604 is used, the tool side 610 of the second blade section 104 will be controlled to have the shape of the first blade section 102 based on the tool insert 606 and the measured data. If the female tool 602 is used, the bag side 612 shape will require the use of the caul 614 to control the shape and ensure that it provides a custom fit to the first blade section 102 based on the tool insert 606 and the measured data.

Accordingly, disclosed is a custom fit blade tip, and method of fabrication that provides for the custom fit of the blade tip over an existing rotor blade to form a rotor blade assembly. The ability to provide for a custom fit enables a controlled thin uniform gap to be formed between the blade tip and the existing blade section in an overlapping region. This controlled thin uniform gap minimizes, if not eliminates, the formation of local shell buckling and fatigue problems when using mechanical fasteners to join the custom fit blade tip and the existing blade section and provides a strong bond if an adhesive bond is used. From a commercial standpoint, there may be no need for grinding to make the parts fit of either the existing blade section or the blade tip in light of the custom fit of the blade tip to the existing blade, thereby reducing associated assembly costs. The custom fit blade tip could also be made as a single piece component instead of a multi-piece component, thereby eliminating the need for any patch or surface finish work.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

This written description uses examples in the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A rotor blade assembly comprising:
a first blade section including a joint end and defining an aerodynamic profile;
a custom fit second blade section including a joint end and defining an aerodynamic profile,
wherein one of the first blade section and the custom fit second blade section includes an inner surface and an outer surface, the inner surface defining a cavity configured to receive the joint end of the other one of the first blade section or the custom fit second blade section in an overlapping configuration defining an overlapping region and a mating joint;
a joining means configured to secure the joint ends of the first blade section and the custom fit second blade section in the overlapping region,
wherein a profile of the outer surface of the custom fit second blade section generally corresponds to the aerodynamic profile of the first blade section such that a substantially continuous aerodynamic profile is defined between the first blade section and the custom fit second blade section when the joint ends are configured in the overlapping configuration.

2. The rotor blade assembly of claim 1, wherein the custom fit second blade section is configured as a custom fit blade tip of the rotor blade assembly.

3. The rotor blade assembly of claim 2, wherein the custom fit blade tip defines a winglet.

4. The rotor blade assembly of claim 1, wherein the joint end of the custom fit second blade section is disposed overlapping the joint end of the first blade section, the joint end of the first blade section being disposed within the cavity formed in the custom fit second blade section.

5. The rotor blade assembly of claim 1, wherein the joint end of the first blade section is disposed overlapping the joint end of the custom fit second blade section, the joint end of the custom fit second blade section being disposed within the cavity formed in the first blade section.

6. The rotor blade assembly of claim 1, wherein a tapered profile is defined along a length of the overlapping region.

7. The rotor blade assembly of claim 1, wherein a stepped profile is defined at the mating joint.

8. The rotor blade assembly of claim 1, wherein the joining means comprises a plurality of fasteners.

9. The rotor blade assembly of claim 1, wherein the joining means comprises an adhesive.

10. The rotor blade assembly of claim 1, wherein the joining means comprises a thermoplastic weld.

11. A rotor blade assembly for a wind turbine, the rotor blade assembly comprising:
a first blade section including a joint end defining a geometric profile;
a custom fit second blade section including a joint end, the custom fit second blade section further including an inner surface defining a cavity having a geometric profile at the joint end substantially inverse to the geometric profile of the joint end of the first blade section so as to receive the joint end of the first blade section in an overlapping configuration and define an overlapping region and a mating joint;
a joining means configured to secure the joint ends of the first blade section and the custom fit second blade section in the overlapping region,
wherein a profile of an outer surface of the custom fit second blade section generally corresponds to an aerodynamic profile of the first blade section such that a substantially continuous aerodynamic profile is defined between the first blade section and the custom fit second blade section when the joint ends are configured in the overlapping configuration.

12. The rotor blade assembly of claim 10, wherein the custom fit second blade section is configured as a custom fit blade tip of the rotor blade assembly.

13. The rotor blade assembly of claim 11, wherein the custom fit blade tip defines a winglet.

14. The rotor blade assembly of claim 11, wherein one of a tapered profile and a stepped profile is defined along a length of the overlapping region.

15. The rotor blade assembly of claim 11, further comprising a plurality of openings defined between the outer surface and an inner surface of the custom fit second blade section, the plurality of openings configured to receive a plurality of fasteners for securing the joint ends of the first blade section and the custom fit second blade sections within the cavity.

16. The rotor blade assembly of claim 11, further comprising an adhesive disposed in a uniform gap formed between the first blade section and the custom fit second blade section in the overlapping region for securing the joint ends of the first blade section and the custom fit second blade sections within the cavity.

17. A method of fabricating a rotor blade assembly of a wind turbine, the method comprising:
obtaining geometric profile data of an existing rotor blade by one of scanning a profile of the existing rotor blade or obtaining a surface impression of the profile of the existing rotor blade;
creating a custom tooling surface based on a determined geometry provided by the obtained geometric profile data;
creating a standardized tooling surface based on standardized tooling data;
combining the custom tooling surface and the standardized tooling surface to create a combined single tooling surface;
laying up a plurality of composite layers on the a combined single tooling surface to form a custom fit blade tip;
installing the custom fit blade tip on the existing rotor blade to form the rotor blade assembly.

18. The method of claim 1, wherein the step of obtaining geometric profile data of an existing rotor blade by scanning is performed by one of a metrology and a 3-D scanner to obtain measurement data.

19. The method of claim 17, wherein the step of creating a custom tooling surface uses additive manufacturing.

20. The method of claim 17, wherein the custom tooling surface is a mold insert.
